(19) United States
(12) Patent Application Publication
(10) Pub. No.: US 2012/0040205 A1
(43) Pub. Date: Feb. 16, 2012

(54) METHOD FOR PRODUCING A PRESS-QUENCHED METAL COMPONENT

(75) Inventors: Franz-Josef Lenze, Lennestadt (DE); Sascha Sikora, Lunen (DE); Andreas Ulrichs, Moers (DE); Lothar Patberg, Moers (DE)

(73) Assignee: THYSSENKRUPP STEEL EUROPE AG, Duisburg (DE)

(21) Appl. No.: 13/202,385

(22) PCT Filed: Jan. 27, 2010
(86) PCT No.: PCT/EP2010/050931

§ 371 Date: Oct. 27, 2011

(30) Foreign Application Priority Data
Feb. 19, 2009 (DE) 10 2009 003 508.7

(51) Int. Cl. C21D 1/18; B32B 15/01; B21D 31/00

(52) U.S. Cl. 428/600; 72/377

(57) ABSTRACT

The invention relates to a method for producing a press-hardened metal component, in which a blank (2) or a semi-finished product (30, 40, 50, 60) is press hardened in a forming tool (12), wherein the blank (2) or the semi-finished product (30, 40, 50, 60) has partial regions (4, 36) with reduced wall thickness and the partial regions (4, 36) with reduced wall thickness are not press hardened. The invention also relates to a press-hardened metal component made of steel or a steel alloy, in particular for a motor vehicle, preferably produced by a method according to the invention, which is not press hardened in at least one partial region (4, 36), wherein at least one partial region (4, 36) that is not press hardened has a reduced wall thickness in comparison with the partial regions that are press hardened.

The invention relates to a method for producing a press-hardened metal component made of steel or of a steel alloy, in which a blank or a semi-finished product is press hardened in a forming tool. The invention also relates to a press-hardened metal component made of steel or of a steel alloy, in particular for a motor vehicle, which component is not press-hardened in at least one partial region.

To produce motor vehicle bodies or housings, components are usually required which have a high degree of hardness. In the case of components made of steel or of a steel alloy, it is possible to achieve a very high strength and a very high degree of hardness by the press hardening method. In this method, a blank or a semi-finished product is hot formed in a tool at temperatures above the austenitising temperature and is then abruptly cooled in this tool. The austenitic structure of the component present during hot forming is converted by the rapid cooling procedure into a martensitic structure of a high strength and hardness. Depending on the stress to be expected in a vehicle body or housing, it is necessary for some components not to have a continuous hardness, but to have regions with a relatively low hardness or with an increased elongation at break. This can be achieved in particular in that the components are not press hardened in the regions in which they are to have a relatively low degree of hardness.

A method is known from WO 2006/038868 A1 for the production of such components, in which the die used for press hardening has superficial recesses in the regions in which the component to be produced is to have a lower degree of hardness. Consequently, during press hardening, the blank does not rest against the die in the region of the recesses, but an air gap is formed between the die and the blank. In this way, the blank is cooled relatively slowly in this region so that the hardness and thus the strength is lower in this region after the component has been press hardened.

However, the described method suffers from the disadvantage that it is expensive to produce the dies provided with the recesses. Furthermore, to produce components which are basically similar but are merely to have different regions of a reduced hardness, it is necessary to provide each component with its own die. This greatly increases the production costs of such components. In addition, the recesses in the die can lead to deformations in the component, so that it is difficult and sometimes even impossible to accurately form the component by this method.

In view of this prior art, the object of the invention is to provide a generic method for the production of a press-hardened metal component and a press-hardened metal component consisting of steel or of a steel alloy, which avoid the disadvantages of the prior art.

This object is achieved according to the invention in a generic method in that the blank or the semi-finished product have partial regions of a reduced wall thickness and the partial regions of a reduced wall thickness are not press hardened.

Due to the reduced wall thickness, the blank or the semi-finished product does not rest directly against the wall of the forming tool in the corresponding partial regions, so that air gaps form between this partial region of the blank or of the semi-finished product and the wall of the tool. When the component is cooled in the press hardening method, the transport of heat from the blank or the semi-finished product to the tool is reduced through the air gaps, thereby entailing slower cooling rates. Thus, the component is not press hardened in these regions. The particular consequence of this is that only a low or even no martensitic structure can form in these partial regions and thus the hardness in these regions is lower and the elongation at break value is greater.

The advantage of this method is based on the fact that in this manner, it is possible with a conventional press hardening tool to produce a component which has partial regions with a reduced hardness or an increased elongation at break value. In particular it is therefore unnecessary to configure the tool in a particular manner in the partial regions which are not to be press hardened. This significantly reduces the production costs.

In a preferred embodiment of the method, the partial regions of a reduced thickness are prepared by stamping the blank or the semi-finished product before being press hardened. The stamping operation produces the recesses in a particularly simple manner. Thus for this purpose, it is possible to use a stamp die or a stamping roller which is particularly advantageous for stamping large regions.

According to a further preferred embodiment of the method, it is possible to achieve a particularly flexible reduction in the wall thickness in that a blank which has patches for increasing the wall thickness is press hardened. The wall thickness of the blank can be changed in a very flexible manner by applying patches to the blank before press hardening. In this respect, the patches are preferably joined in a material-uniting manner with the blank.

A further preferred embodiment of the method is provided in that a composite metal sheet is press hardened, said composite metal sheet comprising at least two blanks, one of the blanks having recesses for the provision of partial regions of a reduced wall thickness. Compared to a conventional blank, a composite metal sheet has the advantage that it is possible to configure the mechanical characteristics of the composite metal sheet in a flexible manner, for example through the choice of different materials for the individual blanks. Furthermore, it is advantageous in connection with the method to make the recesses in one of the blanks of the composite metal sheet, since this can be carried out separately from the other blanks of the composite metal sheet. Thus for example, even in the case of different composite metal sheets, a respective portion of the same blank with the recesses can be used so that this blank can be produced for stock for numerous uses.

In a further embodiment of the method, a “tailored blank”, a “tailored strip” or a “tailored rolled blank” is press hardened.

“Tailored blanks” are individual blanks which are welded together by a joining method to produce a single blank. By this method, for example blanks of the same materials but different sheet thicknesses or different materials of the same or different sheet thicknesses can be welded into a blank. “Tailored strips” are “tailored blanks” consisting of strip-shaped blanks.

It is advantageous to use tailored blanks or tailored strips in the method, because in this manner it is possible to produce components with complex shapes and variable material characteristics. Furthermore, the wall thicknesses in the partial regions can be reduced in a very simple and flexible manner.

The tailored blank preferably has at least one blank without a stamping and at least one blank with a stamping. Alternatively, the tailored blank has at least two stamped blanks of a different thickness.

In the case of so-called “tailored rolled blanks”, a flexible rolling method is used to roll a material over its length into different thicknesses. This allows the thickness to be reduced in the workpieces with a continuous material transition, thereby avoiding hard edges in the transition to the non-press hardened partial regions of the component. In this respect, a tailored rolled blank of previously stamped starting material is preferably press hardened.

The object on which the invention is based is also achieved according to the invention by a generic press-hardened metal component made of steel or of a steel alloy, in particular for a motor vehicle, in that at least one non-press hardened partial region has a reduced wall thickness compared to the press hardened partial regions. The metal component is preferably produced by a method according to the invention.

Due to the reduced wall thickness, it is easily achieved that the corresponding partial regions are not press hardened after the press hardening operation of the metal component. Metal components of this type can advantageously be used for motor vehicle bodies or housings, for example, since they satisfy the variable material characteristics required here and can also be produced in a cost-effective manner.

According to a further embodiment, the metal components can be flexibly adapted to the loading requirements in that the non-press hardened partial regions of the metal component are arranged in a manner appropriate to the load. Since in this respect only the partial regions of a reduced wall thickness have to be arranged accordingly without necessitating an adaptation of the tool required for production, such a component can be produced in a simple and economical manner. In this respect, the non-press hardened partial regions of the metal component are preferably arranged in regions in which the metal component is to have an increased elongation at break.

In a further embodiment, a particularly high degree of hardness or strength of the metal component is achieved in that the metal component consists of a manganese-boron steel, preferably a steel of type 22MnB5.

In a further embodiment of the press-hardened metal component, the partial regions of a reduced thickness are formed by stamping. In this manner, the partial regions of a reduced wall thickness can be produced particularly simply and can be arranged in a flexible manner.

A further preferred embodiment of the press-hardened metal component is provided in that the stampings are configured in strips. This is particularly advantageous, for example if the metal component is to have edges of a relatively low degree of hardness, for example desired bending edges.

In a further embodiment, a more uniform hardness distribution can be achieved in that the stampings are punctiform or rectangular. The term “punctiform stamping” is understood as meaning a circular stamping, for example, but also generally a stamping with a small aspect ratio.

In a further embodiment of the press-hardened metal component, the stampings are configured similarly and/or are distributed uniformly in the non-press hardened partial regions. In this manner, it is possible to achieve regions with a uniform average hardness. Moreover, the formation of similar or uniformly distributed stampings is simpler and more economical. Thus, the semi-finished product for the production of the metal component can be stamped before press hardening, for example using a stamping roller.

However, it is possible to achieve very flexible average hardness characteristics of the metal component due to dissimilar stampings or stampings which are not distributed uniformly. In this manner, an average hardness gradient, for example, can be formed.

In a further preferred embodiment, a press-hardened metal component with a total average hardness between that of a press-hardened and that of a non-press hardened component can be achieved in that the metal component has stampings over substantially its entire surface.

In a further embodiment, a particularly flexible arrangement of the partial regions of a reduced wall thickness is possible in that the press-hardened partial regions of the metal component are provided by patches which increase the wall thickness. By applying patches before press hardening, the wall thickness is increased in some regions so that the wall thickness of the remaining regions is reduced relative thereto. The metal component is then substantially press hardened in the regions of the patches by direct contact with the press hardening tool.

A further embodiment of the press-hardened metal component is provided in that the metal component is produced from a composite metal sheet which comprises at least two blanks, one of the blanks having recesses and/or stampings for the provision of partial regions of a reduced wall thickness. This is advantageous because the blank with the recesses and/or stampings can be produced separately. Furthermore, it is possible to significantly influence the material characteristics of the metal component through the choice of different materials for the blanks.

A particularly flexible and economical production is possible particularly for complex press-hardened metal components in that the metal component is produced from a tailored blank, a tailored strip or a tailored rolled blank. In the case of a tailored blank or tailored strip, blanks of different steels can be used in particular.

Furthermore, it is preferable for the metal component to be produced from a tailored blank consisting of at least two stamped blanks of a different sheet thickness or for the metal component to be produced from a tailored blank or a tailored strip consisting of joined blanks of a different sheet thickness.

It is furthermore preferable for the metal component to be produced from a tailored rolled blank consisting of previously stamped starting material.

Further features and advantages of the invention can be inferred from the following description of exemplary embodiments. In this respect, reference is made to the accompanying drawings, in which:

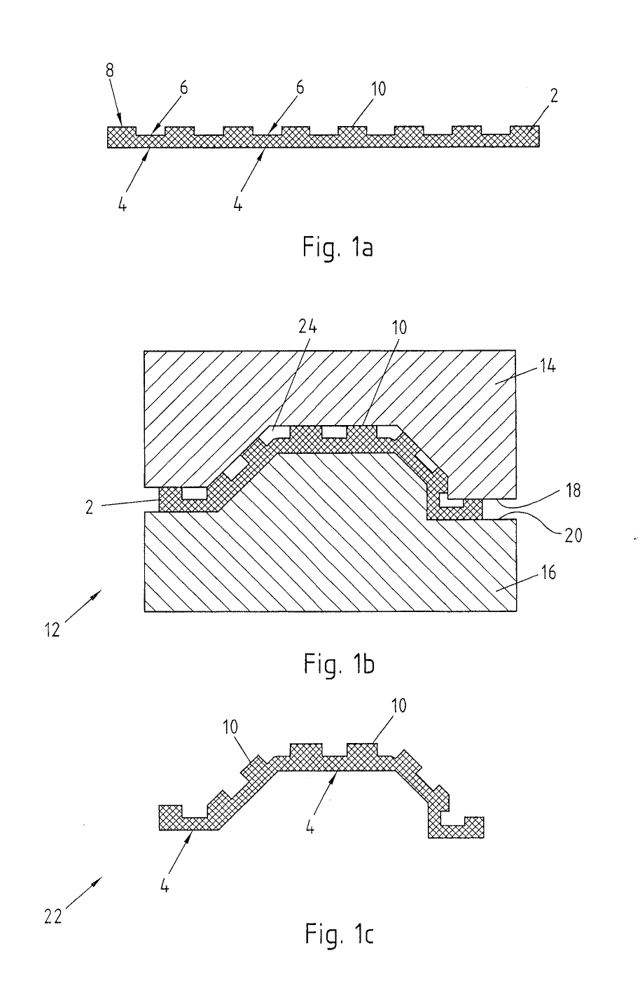

FIG. 1a-c show an exemplary embodiment of a method according to the invention,

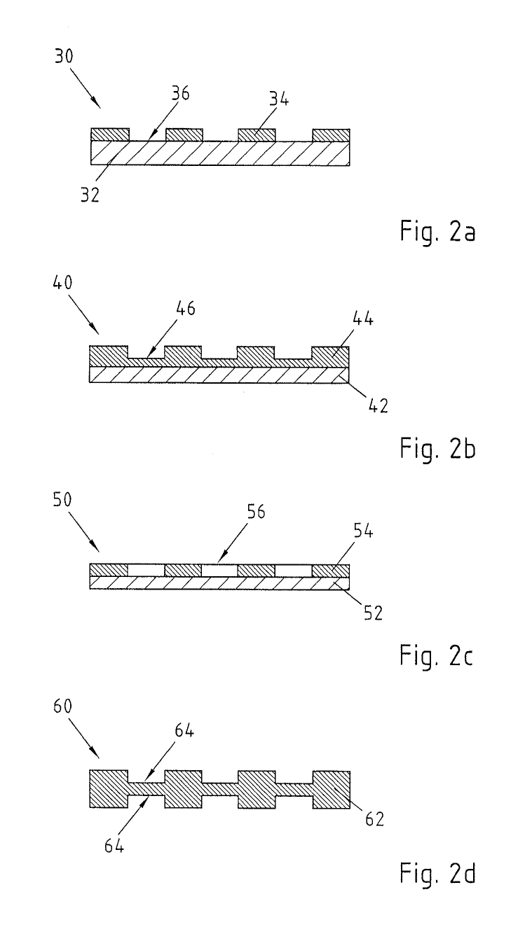

FIG. 2a-d show four exemplary embodiments of a semi-finished product with partial regions of a reduced wall thickness for the production of exemplary embodiments of metal components according to the invention.

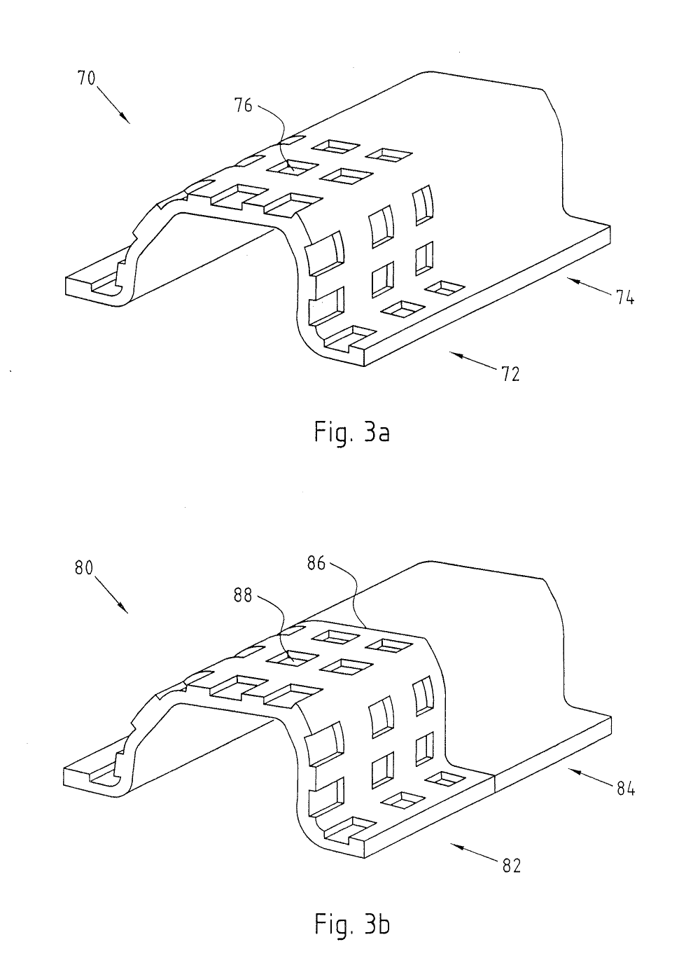

FIG. 3a-b show two exemplary embodiments of a metal component according to the invention,

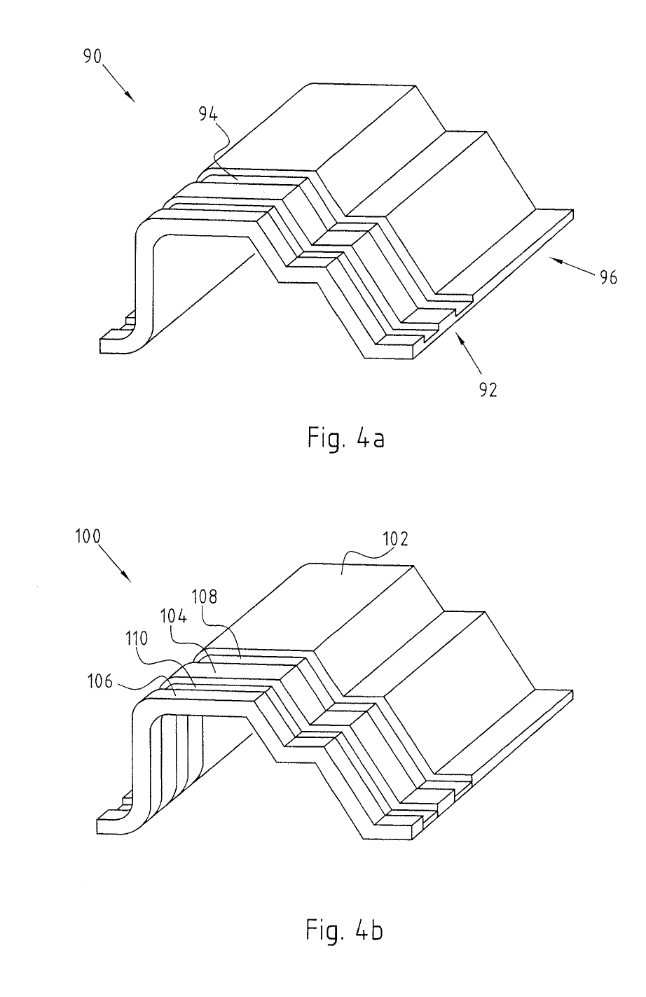

FIG. 4a-b show two further exemplary embodiments of a metal component according to the invention, and

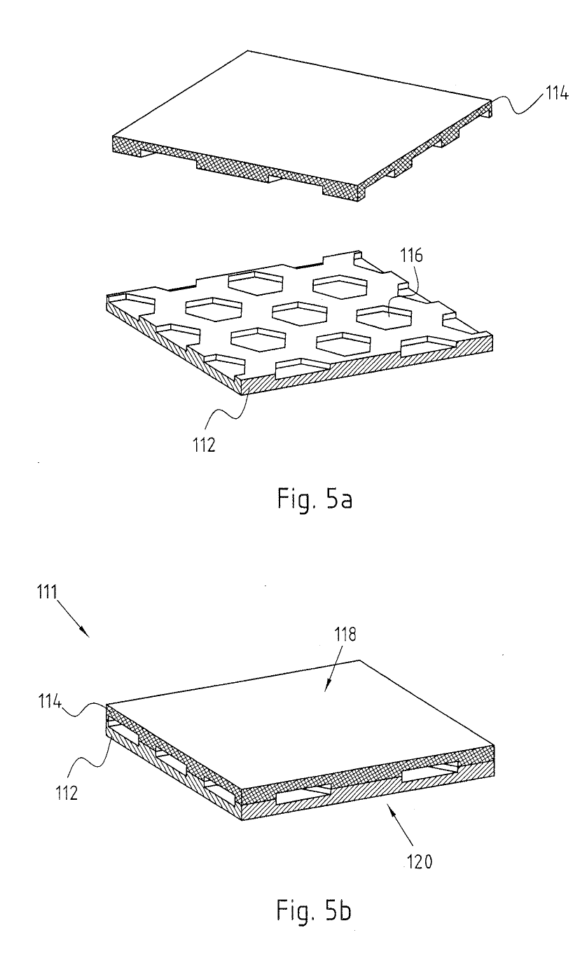

FIG. 5a-b show a further exemplary embodiment of a metal component according to the invention.

FIG. 1a to 1c show an exemplary embodiment of a method according to the invention. FIG. 1a shows a blank 2 which has a reduced wall thickness in partial regions 4. The wall thickness of the blank 2 has been reduced by stampings 6 on the upper side 8 of the blank 2. Consequently, the blank 2 has elevations 10 on its upper side 8. The blank 2 consists of a steel or steel alloy, preferably of a manganese-boron steel, in particular a steel of type 22MnB5. The stampings 6 can be made in the blank 2 by a stamping roller, for example. FIG. 1b shows a press hardening tool 12 with an upper die 14 and a lower die 16. The inner surface 18 of the upper die 14 and the inner surface 20 of the lower die 16 are adapted to the contour of the component to be produced. To produce the component 22, the upper die 14 and the lower die 16 are moved apart. The blank 2 is then positioned between the upper die 14 and the lower die 16, and the upper die 14 and the lower die 16 then move together again. During this movement, the blank 2 is hot formed at temperatures which are preferably above the austenitising temperature. At the end of the hot forming process, the elevations 10 are resting directly against the inner surface 18 of the upper die 14, while the blank 2 is at a distance from the inner surface 18 of the upper die 14 in the partial regions 4 of a reduced wall thickness due to the stampings 6. As a result, a respective air gap 24 is formed between the blank 2 and the inner surface 18 of the upper die 14 in the region of the stampings 6. The formed blank 2 is quenched in the tool 12 to harden it. Due to the direct contact between the elevation 10 and the inner surface 18 of the upper die 14, the blank 2 is cooled very rapidly in this region so that martenitisation of the material results in said region. In the partial regions 4 of a reduced wall thickness, cooling occurs more slowly due to the air gap 24, so that only slight or no martenitisation at all takes place in these regions. At the end of the cooling procedure, the upper die 14 and the lower die 16 are moved apart again and the component 22 which has been formed from the blank 2 and has been press hardened is removed. The finished component 22 is show in FIG. 1c. In the region of the elevations 10, it has a high degree of hardness, while the hardness is lower in the partial regions 4. The partial regions 4 exhibit instead a higher elongation at break value. If partial regions 4 of a reduced wall thickness are distributed uniformly over the component 22, as shown in FIG. 1c in component 22, a component is produced which has an average hardness lying between the hardness of a fully press-hardened component and that of a non-press hardened component.

FIGS. 2a to 2d show exemplary embodiments of semi-finished products with partial regions of reduced wall thickness. The semi-finished product 30 shown in FIG. 2a consists of a blank 32 onto which patches 34 have been applied. The patches 34 are preferably joined in a material-uniting manner with the blank 32. The patches 34 increase the wall thickness of the semi-finished product 30 locally, so that partial regions 36 of a smaller wall thickness compared to the regions with the patches 34 are produced between the patches. During press hardening of the vehicle 30, the patches 34 rest directly against the tool, while an air gap forms in the partial regions 36. The advantage of using patches 34 is that it is possible to change the wall thickness of the semi-finished product 30 in a very simple and flexible manner.

FIG. 2b shows a semi-finished product 40 which is configured as a composite metal sheet. It comprises a first blank 42 and a second blank 44 which is positioned above the first blank 42 and is preferably joined in a material-uniting manner thereto. The second blank 44 comprises stampings 46 so that the wall thickness of the semi-finished product 40 is reduced in these regions. The stampings 46 can be introduced into the second blank 44, for example, before the second blank 44 is joined to the first blank. In this manner, it is possible for example to produce second blanks 44 for stock, to stamp them and to apply said second blanks 44, as required, on first blanks 42 which are to have non-press hardened partial regions. Furthermore, by using different materials for the first blank 42 and the second blank 44, it is possible to influence the material characteristics of the resulting semi-finished product 40 in a flexible manner.

The semi-finished product 50 shown in FIG. 2c is also produced as a composite metal sheet from a first blank 52 and a second blank 54. Unlike the semi-finished product 40 shown in FIG. 2b, the second blank 54 of the semi-finished product 50 does not have any stampings, but recesses 56 which pass through the blank. The recesses 56 can be present in the form of drilled holes, for example. Alternatively, the recesses 56 can be stamped out of the second blank 54. A conventional perforated sheet made of steel or of a steel alloy can preferably be used as the second blank 54, since this is particularly economical and thus the regions of the semi-finished product 50 with a reduced wall thickness can be provided in a simple and advantageous manner.

The semi-finished products or blanks are not restricted to providing the partial regions of a reduced wall thickness through the arrangement of recesses or stampings on one side. Thus, the semi-finished product 60 shown in FIG. 2d has a blank 62, into both sides of which stampings 64 have been made. In this manner, the hot formed semi-finished product 60 has in the thickness-reduced partial regions an air gap on both sides with respect to the upper die and the lower die. This is particularly advantageous when both the upper die and the lower die are actively cooled during press hardening. Consequently, a particularly slow cooling procedure is possible in these partial regions, so that the material has substantially no martensite in this region.

FIGS. 3a and 3b show two exemplary embodiments of the press-hardened metal component. The metal component 70 shown in FIG. 3a has been produced from a locally stamped blank. Thus, the metal component 70 has a first region 72 and a second region 74. Rectangular indentations 76 have been made in the first region 72 before press hardening. The second region 74 does not have any such indentations. During the press hardening process, the metal component 70 was initially hot formed into the shape shown in FIG. 3a from a blank, for example from the blank 2 shown in FIG. 1a, and was then quenched in the tool. While the entire surface of the metal component 70 was in direct contact with the surfaces of the tool in the second region 74, the first region 72 had air gaps in the rectangular stampings 76 so that the component 70 was not press hardened in these areas. The second region 74 of the component 70 is therefore completely press hardened and accordingly has a high degree of hardness, while the first region 72 of component 70 has, on average, a lower degree of hardness where there are indentations 76 due to the non-press hardened partial regions. Such regions with a lower average hardness are preferably arranged in a manner appropriate to the load. Thus, the arrangement is particularly advantageous in the areas in which high elongation at break values are required.

The metal component 80 shown in FIG. 3b differs from the metal component 70 of FIG. 3a in that it is configured as a composite metal sheet. The first region 82 and the second region 84 of the metal component 80 have been press hardened separately from one another and then joined together along the seam 86 by a joining process.

The stampings 76, 88 of the components 70, 80 are not restricted to a rectangular shape, but can also be of any other shape, for example a circle, a polygon or in strips.

FIG. 4a shows a further exemplary embodiment of a press-hardened metal component 90, produced from a locally stamped blank. Analogously to the component 70 shown in FIG. 3a, component 90 has a first region 92 with stampings 94 and a second region 96 without stampings. Accordingly, the component 90 is not press hardened in the region of the stampings 94 which, in this case, are configured in strips, so that the first region 92 has a lower average hardness compared to the second region 96. The metal component 100 shown in FIG. 4b differs from the metal component 90 of FIG. 4a in that it has been produced from tailored blanks or tailored strips of different sheet thicknesses. To produce the metal component 100, a tailored blank 102 and two tailored strips 104, 106 of the same thickness as well as two tailored strips 108, 110 of a smaller thickness have been joined together to produce a semi-finished product and then press hardened. During the press hardening process, a respective air gap was arranged between the semi-finished product and the tool in the region of the tailored strips 108, 110 of a lower wall thickness. As a result, the metal component 100 is not press hardened in the region of the tailored strips 108, 110 of a smaller thickness.

FIGS. 5a and 5b show a further exemplary embodiment of a press-hardened metal component. The metal component 111 shown in FIG. 5b consists of a lower metal component 112 and an upper metal component 114. The lower metal component 112 and the upper metal component 114 are of an identical construction and have been produced independently of one another in a press hardening method. On one side, the two metal components 112, 114 each exhibit honeycomb indentations where there has been no direct contact with the tool during press hardening. Consequently, the metal components 112, 114 are not press hardened in these regions. After press hardening, the metal components 112, 114 are joined together, preferably welded together, with the indented sides facing one another. Due to the stampings in the metal components 112, 114, the resulting composite metal sheet 111 has on average a smaller degree of hardness than a fully press-hardened composite metal sheet. Since the metal components 112, 114 are joined together on their stamped sides, the composite metal sheet 111 advantageously presents smooth outer surfaces 118, 120.

A use, which is not shown, would also be conceivable in which the metal components 112, 114 are initially joined together by their indented sides and are then press hardened, in which case a corresponding shaping can also be provided, if appropriate. In this example as well, the gap force between the sheets produces an, on average, reduced hardness compared to a fully press hardened composite metal sheet.

It is clear to a person skilled in the art that the invention is not restricted to the described exemplary embodiments, but that in particular all combinations of the exemplary embodiments are also possible. The characteristics of the press-hardened metal components can be generally improved in that the blanks, semi-finished products or finished metal components are coated by one or more typical metallic or non-metallic coating concepts. For all composite metal sheets, tailored blanks and tailored strips, it is in principle possible and can possibly be advantageous to use different steel materials.

1. Method for producing a press-hardened metal component made of steel or of a steel alloy, comprising:
press hardening a blank (2) or a semi-finished product (30, 40, 50, 60) in a forming tool (12) such that the blank (2) or the semi-finished product (30, 40, 50, 60) has partial regions (4, 36) of a reduced wall thickness, and wherein the partial regions (4, 36) of a reduced wall thickness are not press hardened.

2. Method according to claim 1, further comprising the step of stamping the blank (2) or the semi-finished product (30, 40, 50, 60) before step of press hardening to provide the partial regions (4, 36) of a reduced wall thickness.

3. Method according to claim 1, wherein the step of press hardening comprises press hardening a blank (2) which has patches (34) to increase a wall thickness thereof.

4. Method according to claim 1, wherein the step of press hardening comprises press hardening a blank (2) which comprises a plurality of blanks of a different wall thickness.

5. Method according to claim 1, wherein the step of press hardening comprises press hardening a composite metal sheet (40, 50), said composite metal sheet (40, 50) comprising at least two blanks (42, 44, 52, 54), one of the blanks (44, 54) having recesses (46, 56) for the provision of partial regions of a reduced wall thickness.

6. Method according to claim 1, wherein the step of press hardening comprises press hardening a tailored blank, a tailored strip, or a tailored rolled blank.

7. A press-hardened metal component made of steel or of a steel alloy, in particular for a motor vehicle, comprising:
a press-hardened metal component which is not press hardened in at least one partial region (4, 36), wherein the at least one non-press hardened partial region (4, 36) has a reduced wall thickness compared to a press hardened partial region of the press hardened metal component.

8. Press-hardened metal component according to claim 7, wherein the at least one non-press hardened partial region (4, 36) of the press-hardened metal component (22, 70, 80, 90, 100, 111) is arranged in a manner appropriate to the load.

9. Press-hardened metal component according to claim 7, wherein the press-hardened metal component (22, 70, 80, 90, 100, 111) comprises a manganese-boron steel, preferably a steel of type 22MnB5.

10. Press-hardened metal component according to claim 7, wherein the reduced wall thickness of the at least one partial region (4, 36) is formed by stampings (46, 64, 76, 94).

11. Press-hardened metal component according to claim 10, wherein the stampings (94) are configured in the form of strips.

12. Press-hardened metal component according to claim 10, wherein the stampings (46, 64, 76) are punctiform or rectangular.

13. Press-hardened metal component according to claim 10, wherein the stampings (46, 64, 76, 94) are configured similarly and/or are distributed uniformly in the non-press hardened partial regions.

14. Press-hardened metal component according to claim 7, wherein the press-hardened metal component (22, 70, 80, 90, 100, 111) has stampings (46, 64, 76, 94) substantially over its entire surface.

15. Press-hardened metal component according to claim 7, wherein the at least one press-hardened partial region of the press-hardened metal component (22, 70, 80, 90, 100, 111) is provided by patches (34) which increase the wall thickness.

16. Press-hardened metal component according to claim 7, wherein the press-hardened metal component (22, 70, 80, 90, 100, 111) is produced from a composite metal sheet (40, 50) which comprises at least two blanks (42, 44, 52, 54) and one of the blanks (44, 54) has recesses (56) and/or stampings (46) for the provision of partial regions of a reduced wall thickness.

17. Press-hardened metal component according to claim 7, wherein the press-hardened metal component (22, 70, 80, 90, 100, 111) is produced from a tailored blank, a tailored strip, or a tailored rolled blank.
